(19) United States
(12) Patent Application Publication
(10) Pub. No.: US 2012/0043168 A1
(43) Pub. Date: Feb. 23, 2012

(54) BRAKE SYSTEMS, CALIPER ASSEMBLIES AND PADS INCORPORATING DIFFERENTIAL ABUTMENTS

(75) Inventors: Lakshmi Narayanan V, Farmington, MI (US); Amar Alamin, Tecumseh (CA); Eric Roszman, Farmington Hills, MI (US); Charles Layton, Beverly Hills, MI (US); Gang Lou, Rochester, MI (US)

(73) Assignee: Akebono Corporation (North America), Elizabethtown, KY (US)

(21) Appl. No.: 12/858,472

(22) Filed: Aug. 18, 2010

(51) Int. Cl. F16D 55/227; F16D 55/22; F16D 65/092

(52) U.S. Cl. 188/72.1; 188/73.31; 188/250 F; 188/73.43

(57) ABSTRACT

The present invention is directed to a unique solution for caliper assemblies, brake pads utilized in such caliper assemblies, support structures utilized in caliper assemblies and disc brake systems containing such caliper assemblies which utilize push pull or pull push abutment designs.

### FIELD OF THE INVENTION

The present invention relates to brake pads and caliper assemblies including such brake pads for use in disc brake systems of motor vehicles which operate in push pull mode or pull push mode during braking. The invention further relates to disc brake systems and methods of braking utilizing such brake pads and caliper assemblies.

### BACKGROUND

Many motor vehicles are equipped with braking systems to allow operators to slow or stop the vehicle when desired. A commonly used braking system is a disc brake system. In general, a disc brake comprises a caliper assembly and a brake disc. The caliper assembly is secured to a vehicle knuckle or suspension components and the disc is connected to the wheel hub of the vehicle. The disc comprises an annular braking band. The caliper assembly comprises two lateral walls disposed on both sides of the disc which are connected by means of connecting members which straddle the brake disc, and may further comprise a support structure. When the vehicle is in motion the disc passes between the two lateral walls of the caliper. At least two brake pads are housed in the caliper assembly inside of the lateral walls, that is on the disc side of the lateral walls, and disposed on each side of the disc. The brake pads comprise a body of friction material and carrier plate, typically a metal such as steel, having disposed thereon a material which creates friction when in contact with the disc. The brake pads are seated in close proximity or adjacent to abutments in the caliper assembly so as to hold them in place during operation of the vehicle. The brake pads are displaceable in a direction perpendicular to the plane of the brake disc. The brake pads can be acted upon by thrusting means such as a hydraulic actuation through a piston to place the friction material of the brake pads in contact with the disc which creates friction force between the pads and the disc to slow down and/or stop the vehicle.

Conventional disc brakes have two sets of abutments on leading and trailing sides of the lateral wall of the caliper or a support bracket to transfer the tangential braking loads from pads. The braking force is reacted by the trailing side abutments for a given direction of rotor or disc rotation. The support bracket of a caliper assembly requires an outer tie bar to share the braking loads between the leading and trailing sides of the support bracket and manage deflections. In some wheel packages, the available axial clearance between the wheel and rotor is limited and does not allow packaging of an outer tie bar on the caliper assembly support bracket. However, from the functional stiffness/stress aspect of the support bracket design, an outer tie bar is required. A currently used design to eliminate the outer tie bar on the support bracket of the caliper assembly is to design the brake pad to have a pull push or push pull feature that will connect the leading and trailing sides of the support bracket and help share the braking loads. In this design the trailing side abutment is referred to as a push abutment due to the pad pushing on the abutment. The leading side abutment is referred to as a pull abutment due to the pad pulling on the abutment. A push pull being defined as a brake design that has push loading occurring before pull loading and vice versa. Hereafter, the terms pull push and push pull will be used interchangeably. A brake that is capable of push pull operation can also be made to function as a pull push. There are push pull designs available that use anchor pins attached to the support as abutments and also support brackets machined with a rail and pressure plate having mating features to achieve push pull function. See U.S. Pat. No. 7,201,258; U.S. Pat. No. 7,377,368; U.S. Pat. No. 5,957,245; US 2007/0240946; US 2007/0056812; and US 2005/0056496 all incorporated herein by reference.

What are needed are brake pads, support brackets, caliper assemblies and disc brake systems with improved push pull operation which provide improved NVH performance, more stable pad motion during braking and adjustment of the system stiffness.

### SUMMARY OF THE INVENTION

In one embodiment the present invention relates to a brake pad comprising a carrier plate having two faces, a top edge, a bottom edge, two opposing side edges, friction material disposed on one face of the carrier plate, two holes in the carrier plate disposed near two opposing side edges, wherein the holes are adapted to receive pins located on or passing through a wall of a caliper body or a support structure wherein the support structure is affixed to the caliper body and the size of the holes is larger than the cross-sectional size of the pins such that the brake pad can adjust the amount of clearance between mating surfaces on the leading and trailing ends to adjust how forces are transmitted during braking and the two opposing side edges each having an abutment surface along each edge adapted to abut to a first and second mating abutment surface of the caliper body or support structure during braking so as to transmit forces from the brake pad to one of the two mating abutment surfaces of the caliper body or support structure.

In another embodiment the invention relates to a caliper assembly adapted for use in a disc brake comprising a caliper body having two opposed caliper walls and a bridge connecting the two opposed caliper walls wherein each caliper wall has an external side and an internal side; one or more brake pads of the invention; optionally inside of the caliper walls is a support structure adapted to support at least one of the brake pads; and two pins projecting from one or more of the caliper body inside walls or surfaces of the support structure adapted to fit into the holes of the brake pads and to hold the brake pads in place; and one or more of the caliper body inside walls or surfaces of the support structure defines a first mating abutment surface and a second mating abutment surface each mating abutment surface adapted to abut to the two abutment surfaces of the one or more brake pads of the invention. The caliper body of the caliper assembly further comprises one or more piston bores adapted for housing one or more pistons used to contact the brake pads with a disc to effectuate slowing or stopping a vehicle.

In one embodiment the caliper assembly is a fixed caliper assembly comprising a caliper body having two opposed caliper walls and a bridge connecting the two opposed caliper walls wherein each caliper wall has an external side and an internal side; one or more brake pads of the invention; one or more of the inside of the caliper walls is adapted to support at least one of the brake pads; and two pins projecting from one or more of the caliper body inside walls are adapted to fit into the holes of the brake pads and to hold the brake pads in place; and one or more of the caliper body inside walls defines a first mating abutment surface and a second mating abutment surface each mating abutment surface adapted to abut to the two abutment surfaces of the one or more brake pads. The caliper body of the caliper assembly further comprises one or more piston bores adapted for housing one or more pistons used to contact the brake pads with a disc to effectuate slowing or stopping a vehicle wherein the pistons engage the brake pads when applied to move the brake pads to engage the rotor.

In another preferred embodiment the caliper assembly utilized is a floating caliper design comprising a caliper body having two opposed caliper walls and a bridge connecting the two opposed caliper walls wherein each caliper wall has an external side and an internal side; one or more brake pads of the invention; inside of the caliper walls is a support structure adapted to support at least one of the brake pads; and one or more surfaces of the support structure contains two pins projecting from the support structure adapted to fit into the holes of the brake pads and to hold the brake pads in place; and one or more of the surfaces of the support structure defines a first mating abutment surface and a second mating abutment surface the mating abutment surfaces adapted to abut to the two abutment surfaces of the one or more brake pads. The caliper body of the caliper assembly further comprises one or more piston bores adapted for housing one or more pistons used to contact the brake pads with a disc to effectuate slowing or stopping a vehicle.

In another embodiment the invention relates to a disc brake system comprising a caliper assembly according to the invention; a rotor attached to a vehicle hub; one or more pistons disposed in the piston bores of the caliper body and attached to a means for actuating the piston; wherein each of the two walls of the caliper assembly is disposed on either side of the rotor with the friction surface of the brake pad located facing the rotor and the caliper bridge is located over an outer edge of the rotor, and when the one or more pistons are actuated the brake pad's friction material comes into contact with the rotor.

The invention also relates to a support structure adapted for use with a caliper body of a disc brake system comprising a support portion having on the inboard side two receptacles for receiving connectors for connecting the support structure to the knuckle or suspension components of a vehicle; two pairs of holes, one pair each on the inboard and outboard side of the support structure, the holes containing pins which are adapted to seat in matching holes in the brake pads and pass through the holes in the brake pads, the length of the pins protruding from the inboard wall of the structural wall is shorter than the distance from the inner wall to the closest rotor braking surface; and two pairs of abutment surfaces to mate with abutment surfaces on the opposing side edges of brake pads.

The invention further comprises a method of braking comprising: a) providing a brake system as described herein; and b) actuating the one or more pistons such that the brake pads come into contact with the disc; wherein the abutment surface on the trailing side of the brake pad engages the corresponding mating abutment surface of the support structure or the inside face of the wall of the caliper body up to about 0.2 g deceleration and above about 0.2 g deceleration additionally the leading side pin or abutment surface engages the corresponding mating abutment surface of the support structure.

It should be appreciated that the above referenced aspects and examples are non-limiting, as others exist within the present invention, as shown and described herein. The brake pads, caliper assemblies and disc brake systems of the invention exhibit improved NVH performance and provide flexibility in design to allow adjustment of the stiffness of the braking structure to optimize component performance.

### DESCRIPTION OF THE DRAWINGS

FIG. 1 is a view of one face of a first embodiment of a brake pad of the invention with the friction material disposed on the face.

FIG. 2 is a view of one face of a second embodiments of a brake pad of the invention which face is opposite of the face with the friction material disposed thereon.

FIG. 3 is a view of the face of the brake pad of the second embodiment with the friction material disposed thereon.

FIG. 4 is view of an inside wall of the outboard half of a fixed caliper body with the first embodiment of a brake pad of the invention disposed therein.

FIG. 5 is a view of the first embodiment of a brake pad disposed in a recess in the inside face of the corresponding inboard wall of the fixed caliper body shown in FIG. 4.

FIG. 6 shows a support assembly with a support structure and two brake pads.

FIG. 7 shows a caliper body assembly.

FIG. 8 shows a caliper assembly comprising a support assembly and the caliper body assembly.

FIG. 9 shows a pin over the rotor brake pad.

FIG. 10 shows another view of the pin over the rotor brake pad.

FIG. 11 shows a pin over the rotor brake pad of the invention assembled with a support structure.

FIG. 12 shows another view of a pin over the rotor brake pad of the invention assembled with a support structure.

FIG. 13 shows a partial brake pad and support assembly and illustrates the abutments which occur during operation.

FIG. 14 shows the inside face of a wall of a fixed caliper body.

FIG. 15 shows a fixed caliper assembly.

FIG. 16 is an exploded view of the assembly of FIG. 6.

### DETAILED DESCRIPTION OF THE PREFERRED EMBODIMENT

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. The present invention is directed to a unique solution for caliper assemblies, brake pads utilized in such caliper assemblies, support structures utilized in caliper assemblies and disc brake systems containing such caliper assemblies which utilize push pull or pull push abutment designs. A caliper assembly functions to house brake pads of a disc brake system and upon activation of the disc brake system place the brake pads in contact with the disc as described hereinbefore. The caliper assembly comprises two opposing walls disposed on each side of the disc each having an external face disposed away from the disc and an internal face disposed toward the disc. One wall is located on the inboard side of the brake disc and one is disposed on the outboard side. Inboard refers to portions of the caliper assembly which are disposed on the side of the rotor which faces the longitudinal center line of the vehicle. Outboard refers to portions of the caliper assembly which are disposed on the side of the rotor which faces away from the longitudinal center line of the vehicle. The two walls may be connected together by a bridge over the disc. As used herein in reference to brake pads, caliper assemblies or support structures, a leading edge means the side of a caliper assembly that a fixed point on a rotor would first enter upon rotation. A trailing edge means the side of a caliper assembly that a fixed point on a rotor would exit upon rotation. As used herein a push abutment is the abutment at the trailing edge. As used herein the pull abutment is the abutment at the leading edge. As used herein stiffness refers to the deflection at a given force.

The caliper assemblies, brake pads and disc brake systems of the invention can be utilized for both fixed caliper and floating caliper designs. In a floating caliper design one or more pistons are located on the inboard side of the disc; the caliper body is unitary and is supported on a support structure which allows the caliper body to move normal to the braking surface. When the pistons are applied the inboard pistons push the inboard pad toward the disc so as to engage the inboard brake pad supported on the inboard side of the support structure with the disc of the brake system. At the same time the hydraulic pressure applied to the piston pushes on the piston bore of the caliper body which moves the caliper body inboard to engage the outboard brake pad with the disc. In one embodiment, only the outboard brake pads are supported on pins as described herein. In another embodiment, both the inboard and outboard brake pads are supported on pins. In this embodiment, the inboard, outboard or both brake pads can be set up to function in a push pull or pull push mode. In a fixed caliper design there are one or more pistons on both sides of the disc. The pistons when engaged push the inboard and outboard pads toward the disc to engage the brake pads with the disc. In this design the brake pads are seated in recesses in the caliper body walls on both the outboard and inboard side and no separate support structure is used.

The present invention is illustrated in a number of exemplary embodiments, as discussed hereinafter. Reference to the figures and reference numbers contained therein are provided to illustrate the invention and it is not intended to limit the description or claims appended hereto to such illustrated embodiments. Each of the components introduced above will be further detailed in the paragraphs below and in descriptions of illustrative examples/embodiments.

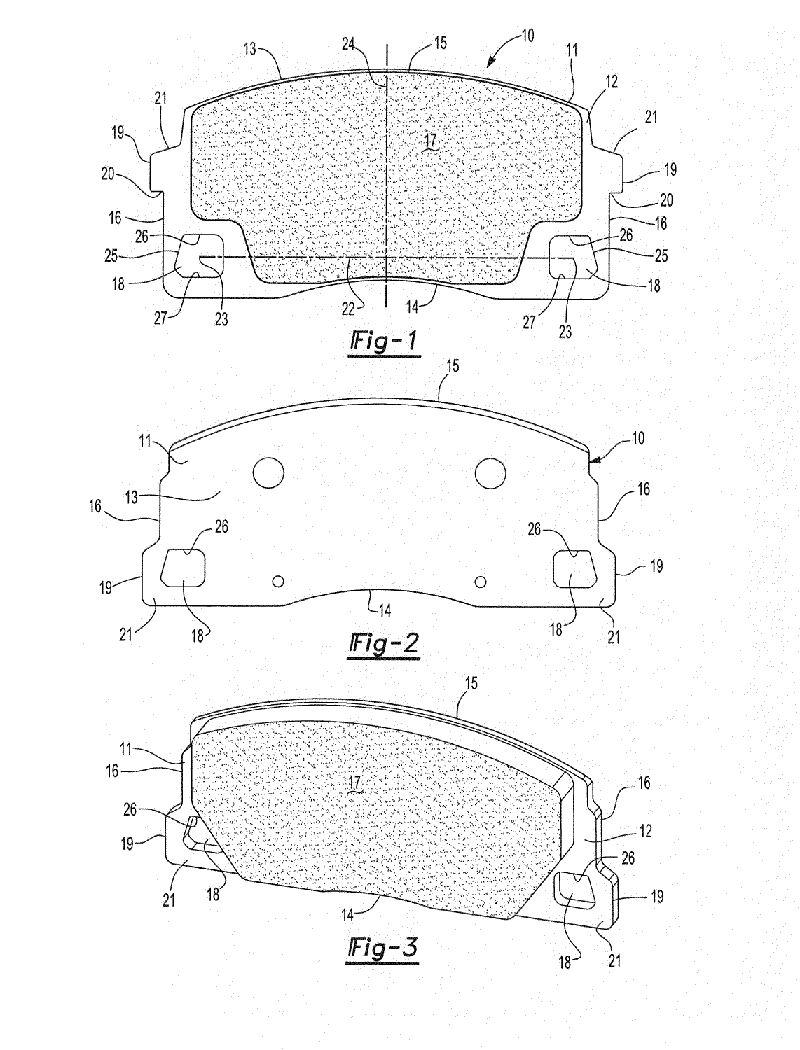

In one embodiment, the invention comprises a brake pad which improves the performance of a disc brake system designed to utilize push pull abutment. A brake pad typically comprises a carrier plate which is adapted to carry a friction material, provide support for the friction material and to withstand braking loads. The carrier plate can be fabricated from any material which performs these functions. Preferably the carrier plate is comprised of a metal such as steel. The friction material is a material that creates friction when contacted with the disc wherein the friction force causes the disc to slow down and thereby slow the vehicle down. The carrier plate of the brake pad provides the basic structure of the brake pad. The carrier plate structure provides the necessary shape to perform the necessary function and is designed to maximize the surface area of friction material which can be contacted with the disc. Referring to FIG. 1 as an example, the carrier plate 11 has two faces 12, 13 which are disposed opposite to one another. The friction material 17 is disposed on one face 12 of the carrier plate 11. The carrier plate from the perspective of the two faces can be of any shape which performs the necessary function. From the perspective of each face the carrier plate 11 has a top edge 15, a bottom edge 14 and two opposing edges 16. The top edge 15 and the bottom edge 14 preferably are arcuate or partially arcuate, with the arc matching the shape of the disc. The top edge 15 as used herein is the edge disposed in the direction of the outer edge of the disc. The bottom edge 14 is disposed opposite of the top edge 15. The friction material 17 is disposed on the face 12 of the carrier plate 11 disposed toward the disc. The friction material 17 has a thickness perpendicular to the face of the carrier plate 11 such that it can provide friction to the disc when the brakes are applied. In the direction perpendicular to the faces 12, 13 of the carrier plate 11, the carrier plate 11 has a thickness. The dimension of this thickness is chosen to provide the necessary structure and stiffness to the brake pad and to withstand the loads applied to the brake pad, carrier plate, during braking. Preferably, this thickness is about 3 mm or greater, more preferably about 4 mm or greater and most preferably 5 mm or greater. Preferably, this thickness is about 10 mm or less, more preferably about 9 mm or less and most preferably 8 mm or less.

The carrier plate of the brake pad contains at least two holes which are adapted to be placed on at least two pins to hold the brake pad in place. The holes are located such that the brake pad can be held in the proper position and such that appropriate pull abutment of the brake pad to the pins can be achieved. Referring to FIG. 1, preferably, the carrier plate 11 of the brake pad 10 contains two holes 18. In a preferred embodiment, the holes 18 are located near the opposing side edges 16 of the carrier plate 11. The location of the holes 18 along each side edge 16 is dictated by the design of the disc brake system and the type of pins utilized. In one embodiment, the pins function to hold the caliper housings in place and are disposed outside of and over the disc. In this embodiment, the holes are located toward the upper edge, or protruding from the upper edge of the carrier plate as shown in FIG. 9. In the embodiments wherein the pins do not function to hold the caliper body and support assembly together, the holes may located in any location along the opposed side edges 16. In one preferred embodiment, the holes 18 are located toward the bottom edge 14 of the carrier plate 11.

The holes in the carrier plate have a sufficient size and shape to hold the carrier plate in place and to facilitate transfer of load as a result of braking to the caliper housing or support structure. The holes are of a size which is greater than the cross-sectional size of the pins. Further the holes are of a size that with respect to the pins that the one or more gaps between the pins and the sides of the holes are created. These gaps are selected such that the system does not seize up due to mechanical forces, manufacturing tolerances or due to the impact of corrosion. Preferably the gaps are chosen to provide the desired abutment profile. The gaps and abutment profile can be adjusted to change the relative stiffness of the braking system under different operating conditions. With respect to each brake pad of the invention there may be one or more gaps depending on the orientation and operational status of the caliper assembly. There may be no gap between an abutment surface of a brake pad and the corresponding mating abutment surface and in this embodiment the gap between the other abutment surface of the brake pad and its corresponding mating abutment surface will be at its maximum size. The one or more specific gaps associated with a brake pad of the invention can range from zero to the maximum possible for the particular design based on the orientation and operational status of the caliper assembly. Preferably, the gaps are about 0 mm or greater and more preferably about 0.5 mm or greater. Preferably, the gaps are about 1.5 mm or less, more preferably about 1.2 mm or less and most preferably about 1.0 mm or less. The shape of the holes can be any shape which facilitates these functions. Among preferred shapes are round, elliptical (oval), square, rectangular, trapezoidal and the like. More preferably the shape is rectangular, trapezoidal or elliptical as such shapes provide for the gaps as discussed herein before. In the embodiments wherein the hole shape is rectangular, square, trapezoidal and the like, the corners of the holes may be rounded instead of exhibiting precise angles. In one preferred embodiment, the sides of the holes form straight lines and the contact condition between the at least one of the sides of the holes and at least one of the pins is a line contact. In one preferred embodiment, the side of the hole adjacent to the opposing edge has a portion which forms a straight line. An example of this is shown in FIG. 1, in particular see holes 18 and sides 25 of the holes. Preferably the side of the hole adjacent to the opposing edge is a straight line wherein the angle of the line defining the straight line of the hole is not parallel to the central line perpendicularly bisecting the center of the brake pad from top to bottom. Line 24 can also be defined as a line perpendicular to a line defined by the center points of the holes where the holes are disposed in the same relative location near each edge of the brake pad, see for example dashed line 22 running from the center points 23 of the holes 18. The holes can be located at any location along the edge of the brake pad and the two holes do not need to be at the same relative location relative to each edge, that is they do not have to be on the same line, for example perpendicular to line 24. Referring the FIG. 1, dashed line 24 illustrates the perpendicular bisecting line and side edges 25 of the holes 18 or show the relative lines referred to. Preferably, the smallest angle between the perpendicular bisecting line and the side adjacent to each opposing edge is 5 degrees or greater. Preferably the angle is about 30 degrees or less and most preferably about 15 degrees or less. In another preferred embodiment the width of the hole is larger near the bottom of the hole as opposed to the width near the top of the hole. See FIG. 1 holes 18 as an example. In this embodiment, the length of the lower wall may be longer than the length of upper wall of the holes. With reference to FIG. 1 the length of wall 27 can be greater than 26 with respect to the holes 18 in the pad. The angle of the wall 25 of each hole compared to the bisecting line can be changed or engineered to adjust the direction of contact forces between the brake pad and the pins.

The brake pad further comprises one or more pad locators. A pad locator is a surface on the edge of the carrier plate or of the holes which functions to define where the pad is located with respect to the abutments of the support structure. Preferably the pad locator is one or more edges upon which the brake pad rests when the brakes are not being applied. The pad locators can be edges of the holes, such as the upper edges, or a portion of the opposing side edges of the carrier plate of the brake pad. Where the pad locators are a portion of the opposing side edges of the carrier plate of the brake pad, such pad locators are preferably defined by a protrusion from each opposing side edge of the carrier plate of the brake pad. Preferably such pad locators defined by such protrusions are surfaces along the bottom of such protrusions, that is the edge of the protrusion located away from the top edge of the carrier plate. Preferably the pad locators defined by protrusions from the opposing side edges are substantially parallel to a line running between the centers of the two holes in the brake pad. Substantially parallel as used in this context means that the smallest angle between the line formed by the pad locator surface and the line running through the center points of the holes is less than 45 degrees, and more preferably less than 30 degrees.

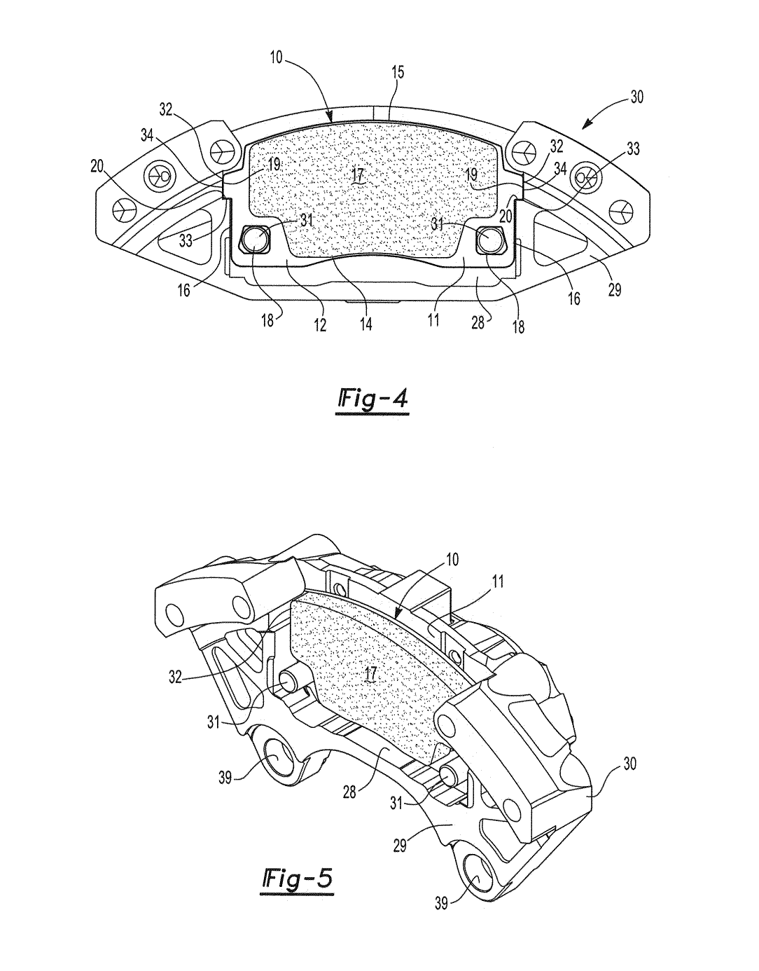

The two opposing side edges of the carrier plate each have a surface adapted to abut to a corresponding mating abutment surface located on the inside face of the wall of the caliper body or the support structure. These surfaces of the opposing side edge and the mating abutment surface of the caliper housing or the support structure function transmit- load from the brake pad to the caliper housing or support structure. The load is applied to the brake pad by the disc during braking. Reference to FIG. 1 illustrates one example of this feature. In FIG. 1 each opposing edge 16 has an abutment surface 19 adapted to abut to mating abutment surfaces. FIG. 4 illustrates the brake pad 10 as part of a caliper assembly and shows two mating abutment surfaces 32 adapted to mate to the abutment surfaces 19 of the brake pad 10 illustrated.

In a preferred embodiment, the opposing side edges of the brake pad carrier plate comprise both abutment surfaces and pad locator surfaces. Preferably the lines defined by the abutment surfaces and the lines defined by the pad locator surfaces are not parallel. Preferably the lines defined by the abutment surfaces and the lines defined by the pad locator surfaces in comparison to one another form an angle of less than 180 degrees and more preferably less than about 100 degrees. Preferably the lines defined by the abutment surfaces and the lines defined by the pad locator surfaces in comparison to one another form an angle of approximately 90 degrees. Approximately as used in this context means the actual angle is within about 10 degrees or less in reference to the stated angle and more preferably about 5 degrees or less in reference to the stated angle.

In another embodiment, the invention is a caliper assembly comprising the brake pads of the invention. The caliper assembly comprises two opposed caliper walls or housings (caliper body). In one embodiment, the caliper assembly further comprises a support structure adapted to support the brake pads and to hold the brake pads in the caliper assembly. The support structure is connected to the walls of the caliper body. The caliper body and the support structure can be comprised of any material which allows such parts to perform their designated function. Preferably the parts are comprised of cast iron or aluminum. The inner faces of the walls of the caliper body or the support structure contain recesses which are adapted to house the brake pads and to define the mating abutment surfaces as described hereinbefore. Preferably the mating abutment surfaces defined by the recesses are substantially perpendicular to the plane of the faces of the brake pad and generally to the plane of the inside face of the wall of the caliper housing or the support structure. The caliper body can comprise one or more parts, preferably one or two parts. As used herein if the caliper body is one part it may be referred to as a unitary. In a floating caliper design the caliper body is preferably unitary. One or both of the caliper walls of the caliper body may contain one or more piston bores for seating pistons therein.

A support structure is a part that supports the brake pads as described herein and is further mechanically affixed to the caliper body. In one embodiment, the support structure supports both brake pads and is adapted to be disposed in some part over the disc. The support structure contains recesses for the brake pads and pins to hold the brake pads in place. Further the support structure is mechanically affixed to the caliper assembly and to the knuckle or suspension components of the vehicle.

The caliper assemblies of the invention utilize pins which mate to the holes in the carrier plates of the brake pads. These pins function to hold the brake pads in place, as a pull abutment to react loads attendant to braking and in some embodiments to connect the parts of the caliper assembly, for instance in a pin over disc (rotor) design. The pins can be placed in the wall of a caliper body or support bracket, be introduced through the caliper body wall or can be located over the disc and connect the caliper body, brake pads and or the support bracket. The material and size of the pins are chosen to allow them to perform the recited function. In the pin over disc (rotor) design the pins have sufficient length to connect all of the necessary parts. Wherein the pins are disposed below the outer diameter of the disc and the length of the pins are chosen to perform the desired function and to terminate before coming into contact with the rotor. Where a support structure is utilized, the pins may mechanically link the support to the caliper body. Either the inside face of the caliper body or of the support structure contains one or more recesses for housing the brake pads. Typically, the recess is formed by casting and/or machining of the material used to form the caliper body or the support structure. The recesses define at least two mating abutment surfaces for each brake pad which are located such that they mate with the abutment surfaces on the opposing side edges of the carriers plates of the brake pads. The mating abutment surfaces function to transfer braking loads, on the mating abutment surface on the trailing edge during braking, this is referred to as the push abutment. During braking the abutment surface of the brake pad on the trailing edge of the carrier plate of the brake pad comes into contact with the corresponding mating abutment surface of the caliper wall or the support structure and the tangential loads are transferred to the mating surface of the caliper wall or the support structure. With respect to each brake pad there is a gap between one of the abutment surfaces and the corresponding mating abutment surfaces of the recess. When the brakes are not being applied a gap can be found between one or both of the pairs of abutment surfaces and corresponding mating abutment surfaces of the brake pad and the recess in which the brake pad is disposed. Preferably the total gap between the corresponding abutment surfaces and mating abutment surfaces for a brake pad and the recess the brake pad is disposed in is about 0 mm or greater, and most preferably 0.5 mm or greater. Preferably the total gap between the corresponding abutment surfaces and mating surfaces for a brake pad and the recess the brake pad is disposed in is about 1.5 mm or less, more preferably about 1.2 mm or less and most preferably about 1.0 mm or less. FIG. 4 illustrates one embodiment of this. Illustrated are pad locator surfaces 20 disposed on opposing side edges 16 of the carrier plate 11 of the brake pad 10 and third and fourth mating surfaces 33 of the recess 28 in the caliper wall 29 of the caliper housing. In a particular caliper assembly of the invention the brake pads of the invention and corresponding pins and recesses in the caliper body wall or support structure can be utilized on the inboard side, the outboard side or both sides of the caliper. Preferably the brake pads of the invention and corresponding structure of the caliper body or support structure are utilized on both the inboard and outboard side on the caliper assembly. In the embodiments of caliper assemblies where only one brake pad of the invention and corresponding caliper wall or support structure are utilized, the other brake pad and caliper wall or support structure utilized may be any design known to one skilled in the art.

The recesses of the caliper wall of the caliper body or in the support structure may further contain pad locator mating abutment surfaces for pad locators disposed on the opposing side edges of the carrier plate of the brake pad. These mating abutment surfaces for the pad locators are adapted to hold the brake pad in the desired location with respect to the caliper or support abutments. In one embodiment, such mating abutment surfaces in the inboard and outboard wall of the support structure form ledges which are substantially parallel to the line defined by the center points of the two pins. In one preferred embodiment, the angle of these such mating surfaces compared to the line defined by the center point of the two holes in the corresponding brake pad is about 80 degrees or greater and about 135 degrees or less. In another embodiment the pins function as pad locators and engage the brake pads at the top surface 26, the bottom surface 27, the side surface 25, or a combination thereof, of the holes of the brake pads. The abutment between the pins and the top surface 26 or bottom surface 27 of the holes in the brake pad may function as a pad locator and also may function to transfer radial braking loads from the brake pad to the caliper body or the support structure.

In a preferred embodiment, the disc brake system according to invention demonstrates at least one first mating abutment surface on the trailing side of the caliper body or support structure which is capable of engaging with the abutment surface of the trailing edge of the brake pads, and the pins are capable of engaging with the hole near the leading edge of the brake pads. The disc brake systems according to the invention demonstrate compressive forces attendant to braking are transferred on the trailing edge first mating abutment surface. The contact at the first mating abutment location is a surface contact condition. Disc brake systems according invention demonstrate the tensile forces attendant to braking are transferred by the hole of the brake pad located near the leading edge of the brake pad corning into contact with the pin located in the hole near the leading edge side of the brake pads. Disc brake systems preferably operate such that the first mating surface on the trailing edge is capable of transferring compressive braking loads and the pin on the leading side is capable of transferring tensile forces. Preferably the disc brake systems according to the invention operate such that the braking forces are primarily compressive and transferred on the first mating surface on the trailing edge up to about 0.2 g deceleration. In another embodiment, preferably the disc brake systems according to the invention operate such that the braking forces are primarily tensile and transferred on the first mating surface on the pin on the leading edge up to about 0.2 g deceleration. The brake system of the invention can be operated such that there is only one location of contact, leading or trailing, up to about 0.2 g deceleration and two locations of contact, leading and trailing, above about 0.2 g of deceleration. The brake systems of the invention provide significant flexibility in how they are set up to operate in that they can be set up in push pull mode or pull push mode. The first recited contact point is the first point at which the brake pad contacts the abutment surface defined, that is push or pull. One significant advantage of the invention is that when the abutment surfaces of the brake pad engage the mating abutment surfaces of the support structure or the inside face of the wall of the caliper body, the contact is a surface contact which provides more stable location of the reaction force between the brake pad and the support structure or the inside face of the wall of the caliper body

In operation, the one or more pistons are engaged which result in engaging the brake pads with the disc to slow down or stop the vehicle. Typically the pistons are engaged by the operator of the vehicle applying the brake, such as by pressing down on the brake pedal. In a preferred embodiment, when the brake is applied hydraulic fluid is forced into the piston bore which causes the pistons to move the one or more of the brake pads and/or caliper bodies to engage the brake pads with the disc (rotor). When the brakes are released the pressure on the pistons is reduced to a point at which the brake pads retract from the disc and if the vehicle is still in motion there is no friction force applied to slow down or stop the vehicle.

FIG. 1 shows a brake pad 10 of the invention. The brake pad 10 has a carrier plate 11 having a first face 12 and a second face 13, not shown. The carrier plate has a bottom edge 14, a top edge 15 and two opposing side edges 16. On the one face 12 of the brake pad 10 is a friction material 17. The carrier plate 11 defines two holes 18 disposed near each opposing side edge 16. Each opposing side edge 16 has an abutment surface 19 adapted to abut to mating abutment surfaces in recesses of a caliper body or a support structure. Each opposing side edge 16 has a pad locator 20 adapted to locate the pad 10 with respect to the mating abutment surface in the caliper body or support structure. This embodiment of the brake pad 10 has two protrusions 21 defined in the opposing side edges 16. The protrusions 21 also define the abutment surfaces 19 and the pad locators 20. FIG. 1 shows two lines of reference. The first line of reference 22 is a line running through the center points 23 of the two holes 18. The second reference line 24 bisects the brake pad 10 and defines a line perpendicular to line 22. Also shown are the side edges 25 of holes 18. These side edges 25 define angles greater than zero as compared to reference line 24. These side edges 25 establish ramps with respect to pins located in the holes 18 during assembly. With respect to the holes 18 a top edge 26 and a bottom edge 27 are defined.

FIGS. 2 and 3 show opposing faces of one embodiment of a brake pad. FIG. 2 illustrates the brake pad from the face 13 of a carrier plate 11 opposing the side having the friction material disposed thereon 12. The carrier plate 11 has a bottom edge 14, a top edge 15 and two opposing side edges 16. The carrier plate 11 defines two holes 18 disposed near each opposing side edge 16. This embodiment of the brake pad 10 has two protrusions 21 defined in the opposing side edges 16. Each protrusion 21 on each edge 16 has an abutment surface 19 adapted to abut to mating surfaces in recesses of caliper bodies or a support structure. Each hole 18 has a surface 26 which function as pad locators adapted to locate the pad 10 with respect to the pins projecting from the caliper bodies or support structure. FIG. 3 shows the carrier plate 11 from the face having the friction material 17 disposed thereon. This perspective also illustrates the thickness of the carrier plate 11 and the friction material 17.

FIG. 4 shows a brake pad as shown in FIG. 1 disposed in a recess 28 of the inside wall 29 of a caliper body 30. Two pins 31 are shown located in the holes 18 of the brake pad 10. Two mating abutment surfaces 32 are defined in the recess 28 and shown in FIG. 4. These mating abutment surfaces 32 mate to the abutment surfaces 19 of the pad 10. Two mating abutment surfaces 33 are defined in recess 28 which are adapted to mate to the edges of the pad locators 20 defined in the brake pad 10. Gaps 34 are defined between the abutment surfaces 19 and mating abutment surfaces 32. FIG. 5 shows the other half of the same structure in FIG. 4 from an angle which illustrates that the carrier plate 11 and the friction material 17 have a certain depth (thickness). Also shown are holes 39 in the support structure for connecting the assembly to a vehicle.

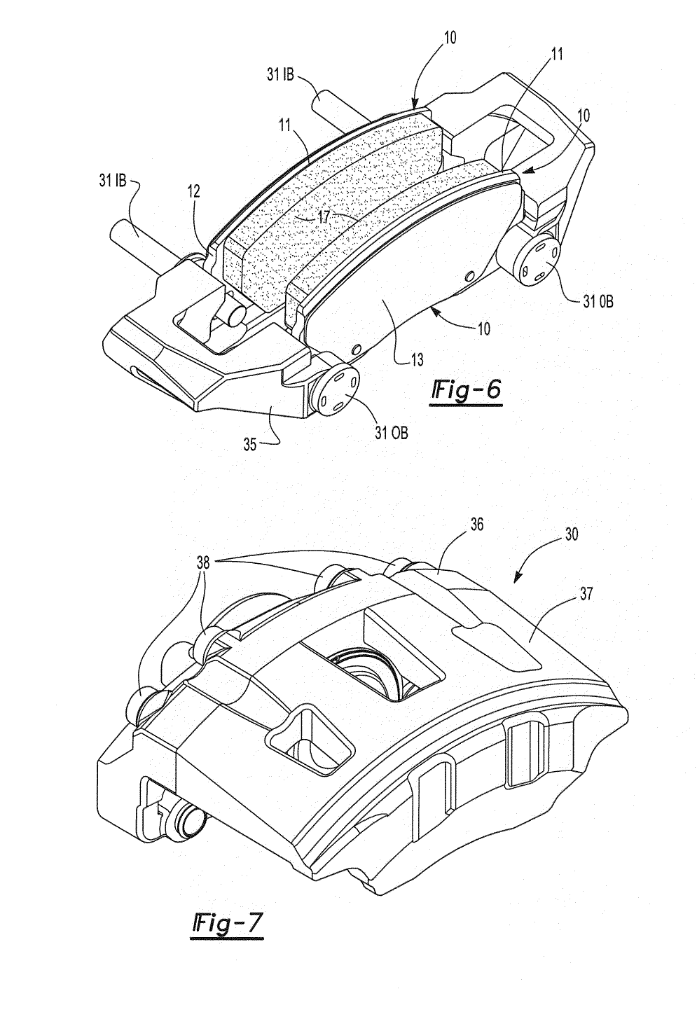

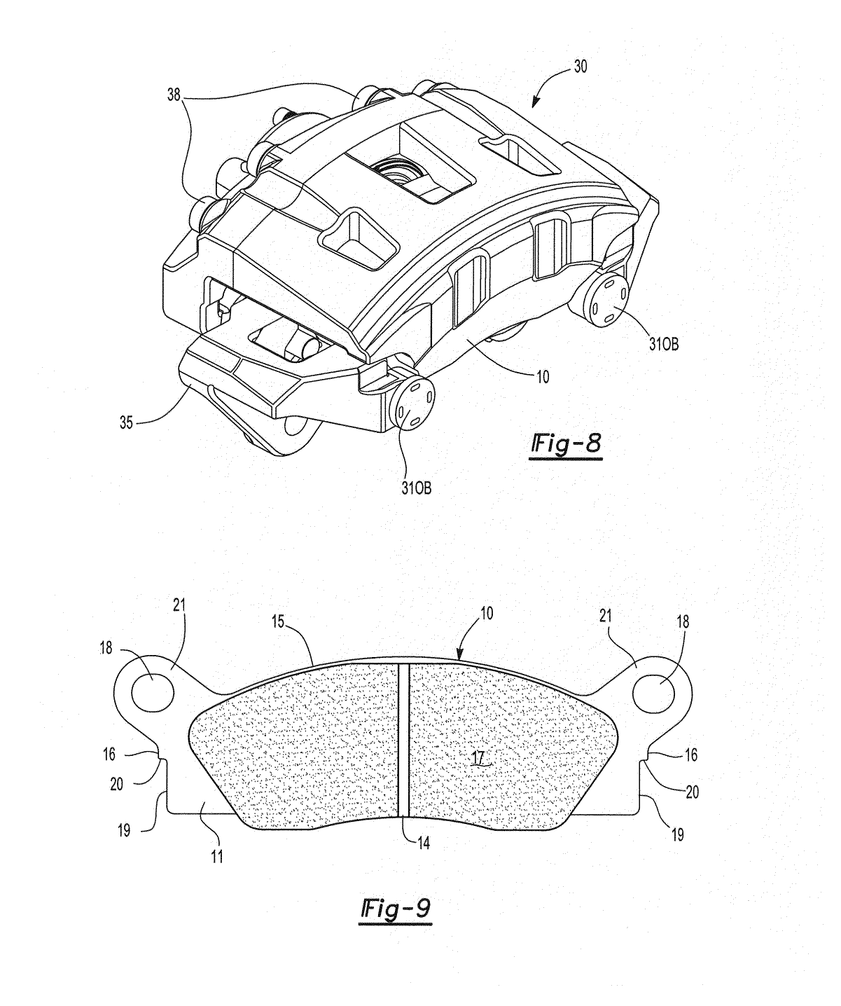

FIGS. 6 to 8 show a support assembly, a caliper body assembly and a caliper assembly. In FIG. 6 a support structure 35 having two brake pads 10 having friction material 17 on the inside faces of carrier 11 of the brake pads 10 is shown. Pins 31 IB (inboard) and 31 OB (outboard) hold the brake pads 10 in place. FIG. 7 shows a caliper body 30 two halves 36 (inboard) and 37 (outboard) assembled by bolts 38. FIG. 8 shows the assembly of the support structure 35 and the caliper body 30. Shown are two parts of the caliper body 36 and 37, a support structure 35, two outboard pins 31 OB and the brake pad 10

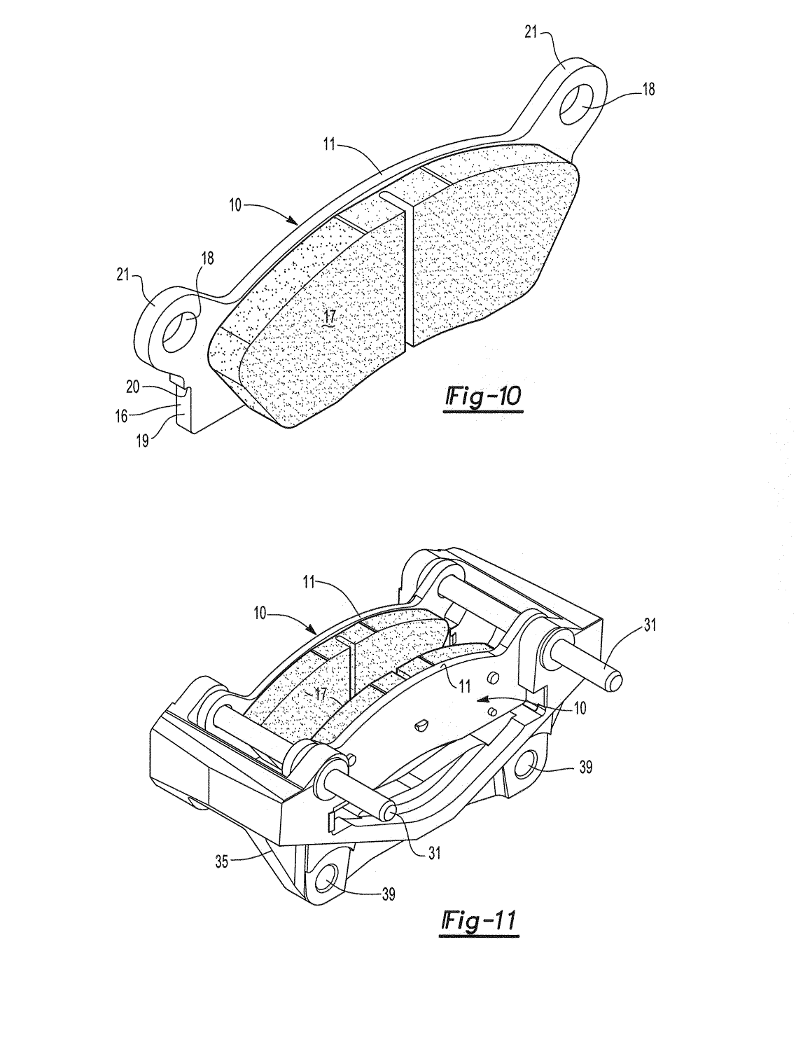

FIG. 9 shows an over the rotor pin type brake pad, FIG. 10 shows the same pad and the thickness of the carrier plate 11 and the friction material 17 and FIGS. 11 and 12 show a support assembly 35 containing such brake pads 10 from two sides, inboard and outboard. The brake pad 10 comprises a carrier plate 11. The carrier plate has a bottom edge 14, a top edge 15 and two opposing side edges 16. On the one face 12 of the brake pad 10 is a friction material 17. The carrier plate 11 defines two holes 18 disposed near each opposing side edge 16 and near the top edge 15 of the brake pad 10. This embodiment of the brake pad 10 has two protrusions 21 defined in the opposing side edges 16 which are located at the top edge 15 of the pad 10. The holes 18 are located in protrusions 21. Each opposing side edge 16 has an abutment surface 19 adapted to abut to mating surfaces in recesses of caliper housings or a support structure. Each opposing side edge 16 has an optional pad locator 20 adapted to locate the pad with respect to the recesses in the caliper housings or support structure. FIGS. 11 and 12 show the two brake pads 10 assembled to a support structure 35 using two pins 31. The holes 39 for connecting a bolt or pin to the support assembly 35 and to the vehicle are shown in FIG. 11.

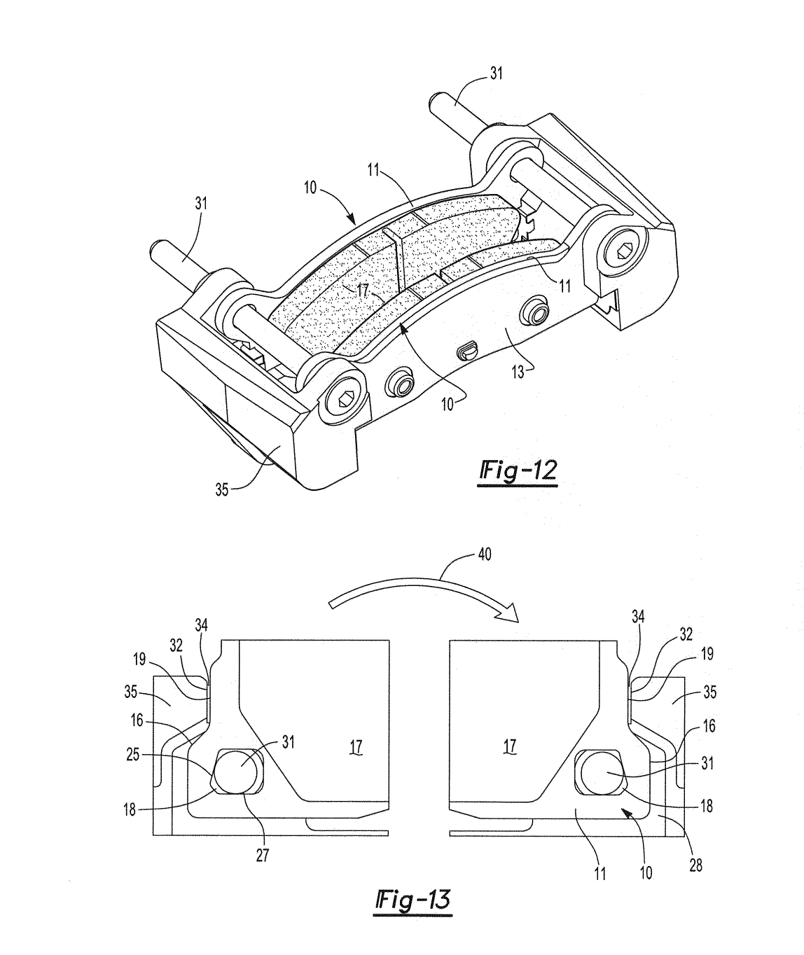

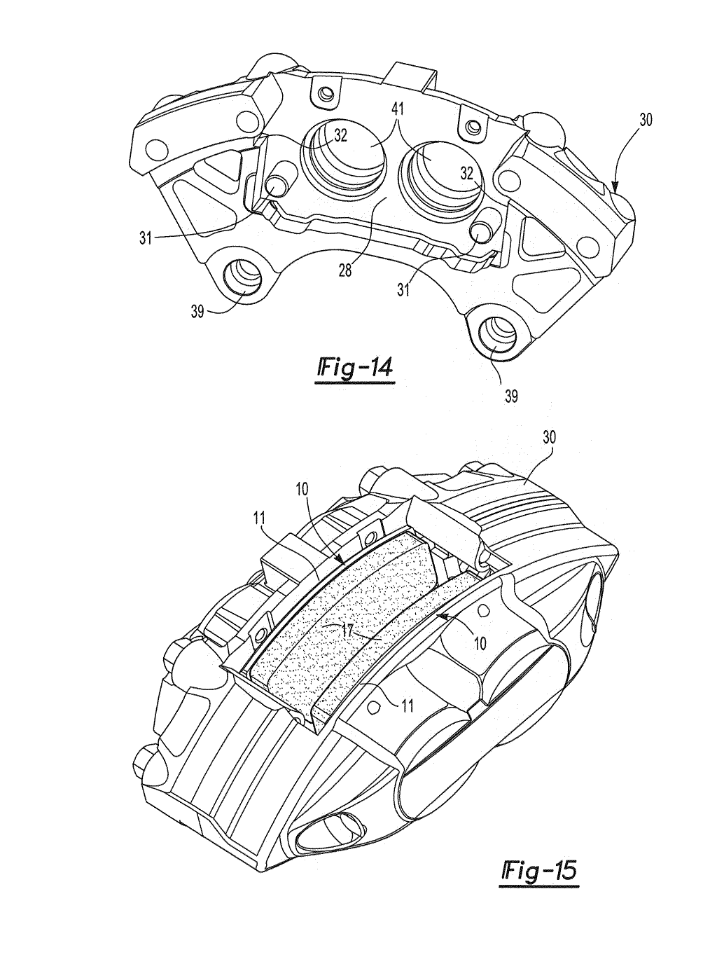

FIG. 13 shows rotor rotation in a clockwise manner and the abutments for a brake pad of the invention when located in a recess of a caliper body inside wall or a support structure inside wall. Shown is a brake pad 10 having a carrier plate 11 with the center cut out located in the recess 28 of a support structure 35. The brake pad 10 has two holes 18 disposed near opposing side edges 16. The brake pad 10 defines abutment surfaces 19 on the two opposing side edges 16. The recess 28 in the support structure 35 defines mating abutment surface 32 which mate to abutment surface 19. Also shown are gaps 34 defined between abutment surfaces 19 and mating surfaces 32 respectively. Arrow 40 shows the direction of motion of the disc or rotor. With this direction of motion of the disc, the trailing tangential abutment is established between the right hand abutment 19 and the corresponding right hand mating abutment surface 32 thereby closing gap 34. The trailing radial abutment is found at the interface of right hand pin 31 and the right hand top edge of hole 18. The leading tangential abutment is found at the interface of left hand pin 31 and side edge 25 of left hand hole 18. The leading radial abutment is found at the interface of the bottom edge 27 of the left hand hole 18 and pin 31. FIG. 14 shows a caliper wall 30 without a brake pad disposed thereon. Shown are two pins 31 for supporting the brake pads two piston bores 41 adapted to allow pistons to engage brake pads and a recess 28 adapted for seating the brake pads 10. The mating abutment surfaces 32 are shown. FIG. 15 shows a complete caliper assembly having a caliper body 30 wherein two brake pads 10 having a carrier plate 11 and friction material 17 disposed in the caliper assembly.

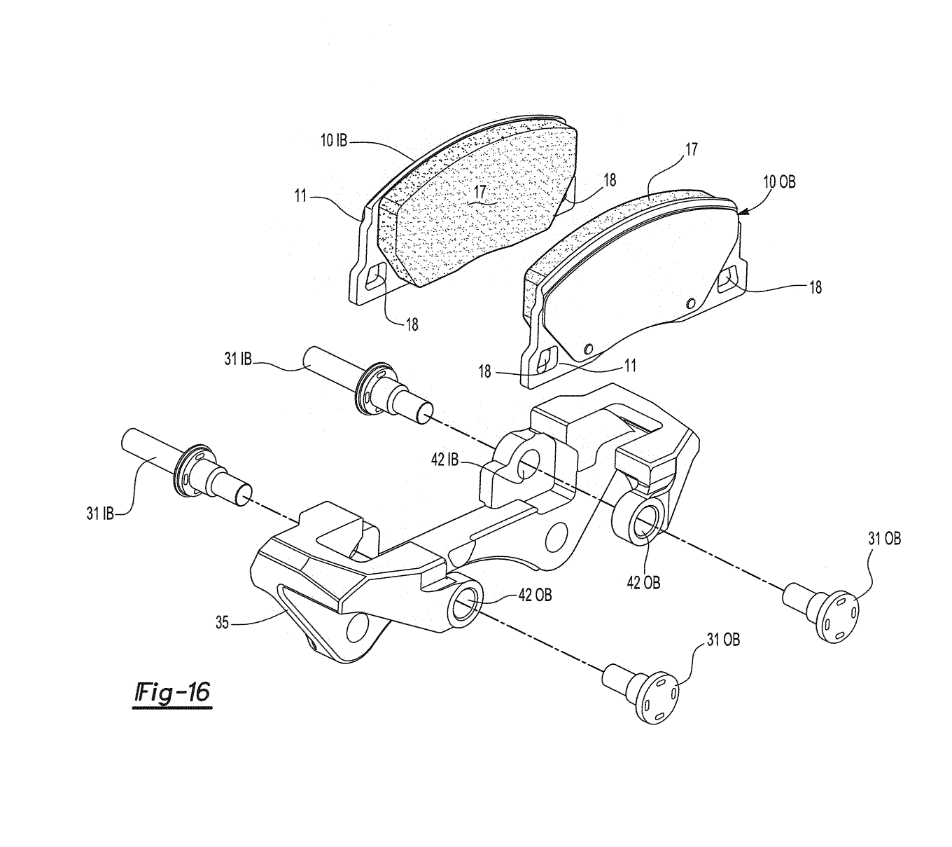

FIG. 16 shows an exploded view of two brake pads 10 OB and 10 IB, an outboard pad and an inboard pad, and a support structure 35. The dashed lines show how the parts are assembled. Shown are two carrier plates 11 each having disposed thereon friction material 17. Also shown are holes 18 in the outboard pad 10 OB and the inboard pad 10 IB. Two inboard pins 31 IB are shown as are two outboard pins 31 OB. Also shown are holes 42 in the support structure adapted to seat the pins 31.

The preferred embodiment of the present invention has been disclosed. A person of ordinary skill in the art would realize however, that certain modifications would come within the teachings of this invention. Therefore, the following claims should be studied to determine the true scope and content of the invention.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Parts by weight as used herein refers to compositions containing 100 parts by weight. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

What is claimed is:

1: A brake pad comprising a carrier plate having two faces, a top edge, a bottom edge, two opposing side edges, friction material disposed on one face of the carrier plate, two holes in the carrier plate disposed near two opposing side edges, wherein the holes are adapted to receive pins located on, or passing through, an inside face of a wall of a caliper body of a fixed caliper assembly or a support structure of a floating caliper assembly wherein the support structure is affixed to the caliper body of a floating caliper assembly and the size of the holes is larger than the cross-sectional size of the pins such that the brake pad can adjust its position with respect to an abutment surface or pin of the caliper body or the support structure to adjust how forces are transmitted during braking and the two opposing side edges have a surface along each edge adapted to abut to a first and second mating abutment surface of the caliper body or support structure during braking so as to transmit forces from the brake pad to one of the mating abutment surfaces of the caliper body or support structure.

2: A brake pad according to claim 1 wherein the brake pad further comprises one or more pad locators.

3: A brake pad according to claim 2 wherein a portion of each opposing side edge is adapted to function as pad locators.

4: A brake pad according to claim 3 wherein the opposing side edges have protrusions wherein a surface of each protrusion is adapted to abut to the first and second mating abutment surfaces of the inside face of the wall of the caliper body or the support structure.

5: A brake pad according to claim 4 wherein the opposing side edge protrusions further each contain a surface adapted to function as a pad locator which pad locators are adapted to abut to third and fourth mating abutment surfaces on the inside face of the wall of the caliper body or support structure.

6: A brake pad according to claim 1 wherein the gap between the pins and the side edge of the holes when the brakes are not engaged is from about 0.1 mm to 0 mm.

7: A brake pad according to claim 6 wherein the geometric shape of the holes is such that the direction of contact forces between brake pad and pins can be adjusted.

8: A brake pad according to claim 7 wherein the shape of the holes is round, square, rectangular, trapezoidal or elliptical.

9: A brake pad according to claim 8 wherein the shape of the holes is trapezoidal and the side of the hole closest to the opposing edge is angled such that the length of the lower wall of the hole is longer than the upper wall of the holes.

10: A brake pad according to claim 1 wherein each of the holes may be located at any position along each of the opposing side edges.

11: A caliper assembly adapted for use in a disc brake comprising a caliper body having two opposed walls and a bridge connecting the two opposed caliper walls wherein each caliper wall has an external face and an internal face; two brake pads comprising a carrier plate having two faces, a top edge, a bottom edge, two opposing side edges, friction material disposed on one face of the carrier plate, two holes in the carrier plate disposed near two opposing side edges, wherein the holes are adapted to receive pins located on, or passing through, art inside face of a wall of a caliper body of a fixed caliper assembly or a support structure of a floating caliper assembly wherein the support structure is affixed to the caliper body of a floating caliper assembly and the size of the holes is larger than the cross-sectional size of the pins such that the brake pad can adjust its position with respect to an abutment surface or pin of the caliper body or the support structure to adjust how forces are transmitted during braking and the two opposing side edges have a surface along each edge adapted to abut to a first and second mating abutment surface of the caliper body or support structure during braking so as to transmit forces from the brake pad to one of the mating abutment surfaces of the caliper body or support structure; affixed to the caliper body is a support structure adapted to support at least one of the brake pads; and two pins projecting from, or through, the support structure of a floating caliper assembly or the inside wall of the caliper body of a fixed caliper assembly adapted to fit into the holes of the brake pads and to support the brake pads; wherein the support structure or the inside wall of the caliper body has one or more recesses defined therein each of which is adapted to receive one of the brake pads, the recess defining a first mating abutment surface and a second mating abutment surface each mating abutment surface adapted such that the trailing opposing side edge of the brake pad abuts to the first mating abutment surface during braking.

12: A caliper assembly according to claim 11 wherein the arrangement of the pins in the caliper body or support structure and the holes in the brake pad define where the brake pad is located with respect to the inside face of the wall of the caliper body or support structure.

13: A caliper assembly according to claim 11 wherein the recess in the inside face of the wall of the caliper body or support structure further defines a third mating abutment surface and a fourth mating abutment surface adapted to function to locate the brake pad with respect to the inside face of the wall of the caliper body or support structure.

14: A caliper assembly according to claim 11 wherein gaps between the side edges of the brake pads having a surface along each edge and the first mating abutment surface and the second mating abutment surface of the inside face of the wall of the caliper body or the support structure are selected so as to transmit forces from the brake pad to the wall or pins of the caliper body or support structure during braking.

15: A caliper assembly according to claim 11 wherein the caliper is a fixed caliper having one or two caliper body inside walls comprising two pins projecting from, or through, the inside wall of the caliper body adapted to fit into the holes of the brake pads and to support the brake pads; and one or more recesses defined therein each of which is adapted to receive one of the brake pads, the recess defining a first mating abutment surface and a second mating abutment surface.

16: A caliper assembly according to claim 15 wherein two caliper body inside walls comprising two pins projecting from, or through, the inside wall of the caliper body adapted to fit into the holes of the brake pads and to support the brake pads; and two recesses defined therein each of which is adapted to receive one of the brake pads, the recess defining a first mating abutment surface and a second mating abutment surface.

17: A caliper assembly according to claim 11 wherein the caliper is a floating caliper having a support structure affixed to the caliper body of the caliper assembly one or two sets of two pins projecting from, or through, support structure adapted to fit into the holes of the brake pads and to support the brake pads; and one or more recesses defined therein each of which is adapted to receive one of the brake pads, the recess defining a first mating abutment surface and a second mating abutment surface.

18: A caliper assembly according to claim 17 wherein the support structure has two sets of two pins projecting from, or through, support structure adapted to fit into the holes of the brake pads and to support the brake pads; and two recesses defined therein each of which is adapted to receive one of the brake pads, the recess defining a first mating abutment surface and a second mating abutment surface.

19: A method of braking comprising:
a) providing a brake system comprising;
i) caliper assembly adapted for use in a disc brake comprising a caliper body having two opposed walls and a bridge connecting the two opposed caliper walls wherein each caliper wall has an external face and an internal face, optionally affixed to the caliper body is a support structure adapted to support at least one of the brake pads; two brake pads comprising a carrier plate having two faces, a top edge, a bottom edge, two opposing side edges, friction material disposed on one face of the carrier plate, two holes in the carrier plate disposed near two opposing side edges, wherein the holes are adapted to receive pins located on, or passing through, an inside face of a wall of a caliper body of a fixed caliper assembly or a support structure of a floating caliper assembly wherein the support structure is affixed to the caliper body of a floating caliper assembly and the size of the holes is larger than the cross-sectional size of the pins such that the brake pad can adjust its position with respect to an abutment surface or pin of the caliper body or the support structure to adjust how forces are transmitted during braking and the two opposing side edges have a surface along each edge adapted to abut to a first and second mating abutment surface of the caliper body or support structure during braking so as to transmit forces from the brake pad to one of the mating abutment surfaces of the caliper body or support structure; and,
two pins projecting from, or through, the support structure or the inside wall of the caliper body adapted to fit into the holes of the brake pads and to support the brake pads; wherein the support structure or the inside wall of the caliper body has one or more recesses defined therein each of which is adapted to receive one of the brake pads, the recesses defining abutment surfaces and each surface being capable of engaging corresponding mating surface on the pad;
ii) a rotor attached o a vehicle wheel hub; and
iii) one or more pistons attached to a means for actuating the piston; wherein each of the two walls of the caliper assembly is disposed on either side of the rotor with the friction surface of the brake pad located facing the rotor and the caliper bridge is located over an outer edge of the rotor, and when the one or more pistons are actuated the brake pads friction material comes into contact with the rotor; and
b) actuating the one or more pistons such that the brake pads come into contact with the disc;
wherein:
A) the abutment surface on the trailing side of the brake pad engages the corresponding mating abutment surface of the caliper body or support structure up to about 0.2 g deceleration and above about 0.2 g deceleration additionally the leading side pin or abutment surface engages the corresponding mating abutment surface of the caliper body or support structure, or
B) up to about 0.2 g deceleration the leading side pin or abutment surface engages the corresponding mating abutment surface of the caliper body or support structure and above about 0.2 g deceleration additionally the abutment surface on the trailing side of the brake pad engages the corresponding mating abutment surface of the caliper body or support structure.

20. A method according to claim 19 wherein the contact condition of the abutment surface of the carrier plate with the corresponding mating abutment surface of the support structure of caliper body is a surface contact.
